(19) United States
(12) Patent Application Publication
(10) Pub. No.: US 2017/0321429 A1
(43) Pub. Date: Nov. 9, 2017

(54) Multi-Layer Ceiling Tile

(71) Applicant: AJK Design Studio Inc., Oakland, CA (US)

(72) Inventor: Annie Kantor, Oakland, CA (US)

(21) Appl. No.: 15/587,199

(22) Filed: May 4, 2017

Related U.S. Application Data
(60) Provisional application No. 62/331,560, filed on May 4, 2016.

(51) Int. Cl. E04F 13/08; E04B 9/18; E04B 9/06; B23K 26/384; E04B 9/00; E04B 9/04; B23K 103/12; B23K 103/10; B23K 103/04

(52) U.S. Cl. CPC E04F 13/0866; E04F 13/0862; E04B 9/18; E04B 9/067; E04B 9/045; B23K 26/384; E04B 9/001; B23K 2203/10; B23K 2203/04; B23K 2203/12

(57) ABSTRACT

A ceiling tile comprises a first layer of material and a second layer of a structurally stiff material distinct from the material of the first layer, positioned to be below the first layer when installed in a ceiling, wherein the second layer can support its weight and the weight of other layers. The first layer is visible through the openings in the second layer when installed. The second layer might be steel, aluminum, copper, bronze, brass, or iron with openings cut into the second layer. The first layer can be acoustical fiber, wool, fabric, wood, leather, rubber, and acrylic and supported the second layer, with the openings being sufficiently arranged so that the first layer is fully supported by portions of the second layer that are not the openings. Three or more layers are also possible, with some or all of the layers are visible through lower layers.

### FIELD OF THE INVENTION

The present invention relates generally to ceiling tiles used for decorative and functional purposes and more particularly to ceiling tiles having multiple layers of distinct materials where some layers are visible through openings in other layers.

### BACKGROUND

Ceiling tiles can provide soundproofing and cover for building structures, piping, ducts, insulation, etc. A common ceiling tile is square and made of a homogeneous material and that can limit design options. Some ceiling tiles might have openings for lights, vents, sprinklers, etc. but those are largely functional.

### SUMMARY

In general, a ceiling tile might comprise a first layer of material suitable for use in ceiling tiles, a second layer of a structurally stiff material, positioned to be vertically below the first layer when installed in a ceiling, wherein a material is structurally stiff when it can support its own weight and the weight of other layers placed above the second layer, and wherein the second layer is of a material distinct from the material of the first layer, and openings in the second layer such that, when installed in the ceiling, the first layer is visible through the openings in the second layer.

The first layer can be felt and supported by the second layer, with the openings being sufficiently arranged so that the first layer is fully supported by portions of the second layer that are not the openings. The first layer thus might be one or more materials selected from a group comprising acoustical board, acoustical fiber, wool, fabric, wood, leather, rubber, and acrylic. The first layer might be permeable to air, but block large particles, thus acting as an air filter.

The second layer might be metallic and the openings in the second layer might be a cut metal design. The openings in the second layer might be formed by laser cutting a sheet of the material of the second layer. The second layer might be one or more materials selected from the group comprising steel, aluminum, copper, bronze, brass, or iron. The second layer might be of a thickness to compensate for sagging.

In alternative embodiments, there are three or more layers and some or all of the layers are visible through lower layers. For example, there might be a third layer, positioned to be vertically below the first layer and above the second layer when installed in a ceiling, wherein the third layer is of a material distinct from the material of the first layer and the material of the second layer. The openings in the third layer might be such that, when installed in the ceiling, the first layer is visible through the openings in the second layer and the third layer openings.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustrative example of an environment in accordance with at least one embodiment.

FIG. 2 is an illustrative example of a cross-section of a two-layer ceiling tile.

FIG. 3 is an illustrative example of a cross-section of a three-layer ceiling tile.

FIG. 4 is an illustrative example of a top view of a two-layer ceiling tile.

FIG. 5 shows a ceiling tile with a metal layer and a felt layer.

FIG. 6 shows another ceiling tile.

FIG. 7 shows a ceiling tile with layers of metal, felt, and acoustic board.

FIG. 8 shows a ceiling tile from an angled view.

FIG. 9 shows a ceiling tile with a laser cut metal layer and a second metal layer above.

FIG. 10 is a view of a ceiling tile with metal under acoustic board and/or metal.

FIG. 11 shows another example of a ceiling tile.

FIG. 12 shows an example of an installed ceiling comprising ceiling tiles with a metal layer under a felt layer where the felt layer is visible to occupants of an office environment.

FIG. 13 shows another example of an installed ceiling comprising ceiling tiles with a metal layer under a felt layer.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Various examples are provided herein of ceiling tiles and their construction and use.

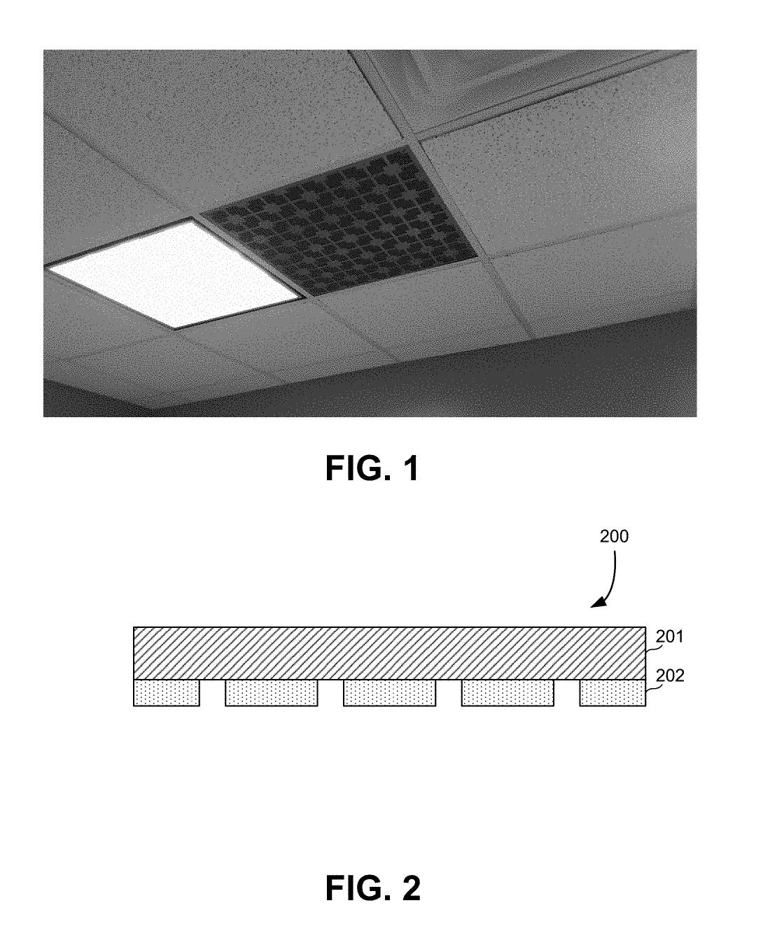

FIG. 1 shows an example of a ceiling tile according to aspects of the present invention. As shown, the ceiling tile has a layer of felt above a layer of metal with an artistic pattern cut from the layer of metal to expose the layer of felt according to that pattern. The layers can be attached to each other with adhesives or mechanical connectors such as rivets. However, ceiling tiles might also maintain the layers with just layers being supported by lower layers.

The use of multiple layers can provide a three-dimensional visual effect, as upper layers (those closer to the structure of the ceiling) are higher and are visible through openings in lower layers (the layers closer to the space of the room). In this manner, substantially flat layered materials can be used to create interesting three-dimensional visual effects for tiles.

FIG. 2 shows a cross-section of a ceiling tile 200, with a first layer 201, such as felt, and a second layer 202, such as a cut metal sheet.

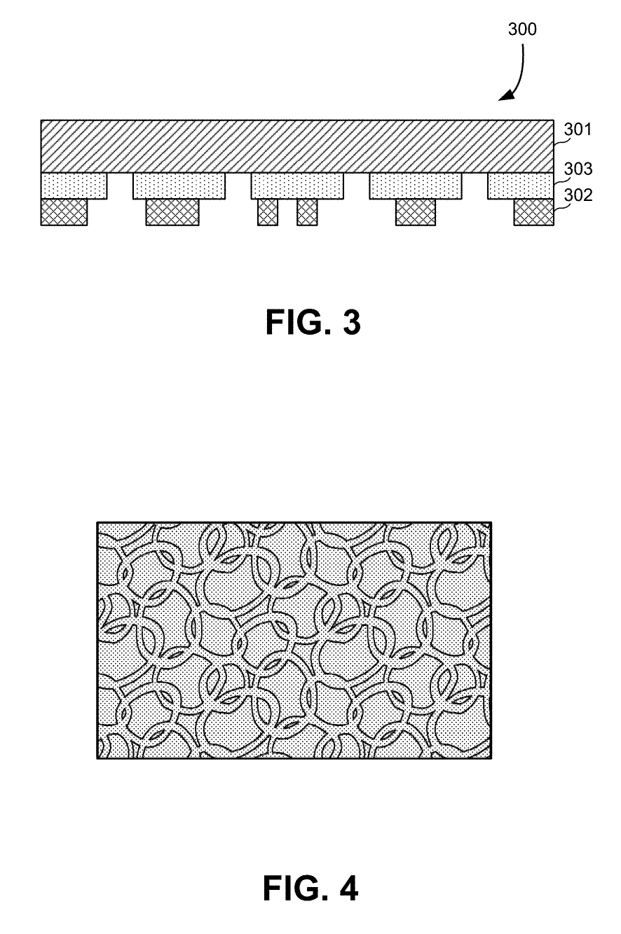

FIG. 3 shows a cross-section of a ceiling tile 300, with a first layer 301, such as felt, and a second layer 302, such as a cut metal sheet, and a third layer 303 of another material. Note that portions of the third layer 303 and the first layer 301 are visible through the second layer 302.

FIG. 4 shows a top view of a ceiling tile, as would be seen looking up at an installed ceiling tile. Note that portions of the first layer are visible through the second layer.

In some embodiments, there can be structural support behind the first layer that is not normally visible once installed, if needed or desired.

The first layer can be felt and different types of felt are possible, such as acoustic felt, flame resistant felt.

As has now been described, a ceiling tile can be provided for a ceiling. The tiles can also be used for an enclosure or a wall. The tiles provide sound absorption, a barrier for sound, a barrier for temperature and/or provide an artistic architectural element.

The metal portion of the tiles can be cut by a laser cutter and the type of metal, pattern and color of felt or other additional layers can be individually selected. The felt might be selectable from a large number of colors, such as 64 colors or might be acoustic board or a different layer of metal. The multi-layer tiling can be used in a suspended ceiling to provide fashionable function with a blend of premium metals and sound absorbing materials. The ceiling tiles can be square, rectangular, or other shapes. The tiles can be used in commercial, hospitality and/or residential spaces. The metals might be steel, bronze or brass, etc. The tiles can be engineered to be lightweight and compliant with seismic requirements, as well as being sound absorbent when backed with acoustic board or felt. The particular materials might be determined by functional requirements, aesthetics, budget and other considerations. The metal can be solid or perforated, as well as laser-cut. Perforated metal can be used as a backing. The tiles can also be used in front of lights, such as troffers.

Where a felt layer is mentioned, it should be apparent upon reading this disclosure that an acoustic board or other material providing similar functionality could be used instead of felt. For example, where felt is disfavored (such as in large commercial settings), painted acoustic board of similar covering might be used instead.

The tiles can be used to create interesting patterns that play with positive space and/or negative space. Some of the patterns abstract architecture, such as bridges, natural shapes and geometric shapes. Some can evoke the motion, and commotion, of bridge traffic, or a perforated grid capturing the rhythm of girders on bridges. The materials can include lightweight square modules or precision laser-cut steel, bronze, brass or aluminum, finished in various powder coat colors or primed for a paint-to-match option. Modules might be standard 24 inch squares. The repeat may be scaled small, medium or large, compatible with suspended ceiling systems.

In some variations, the tiles are not symmetric about quarter-turn rotations, i.e., the pattern is different left-to-right versus top-to-bottom. In such cases, a ceiling might be patterned with one set of tiles, but with the tiles rotated to provide different orientations from other tiles in the ceiling. For example, tiles with lines running predominantly from the front of the room to the back of the room might be placed in alternating locations, as in a checkerboard pattern, and the remaining tiles placed with their lines running predominantly from side to side in the room.

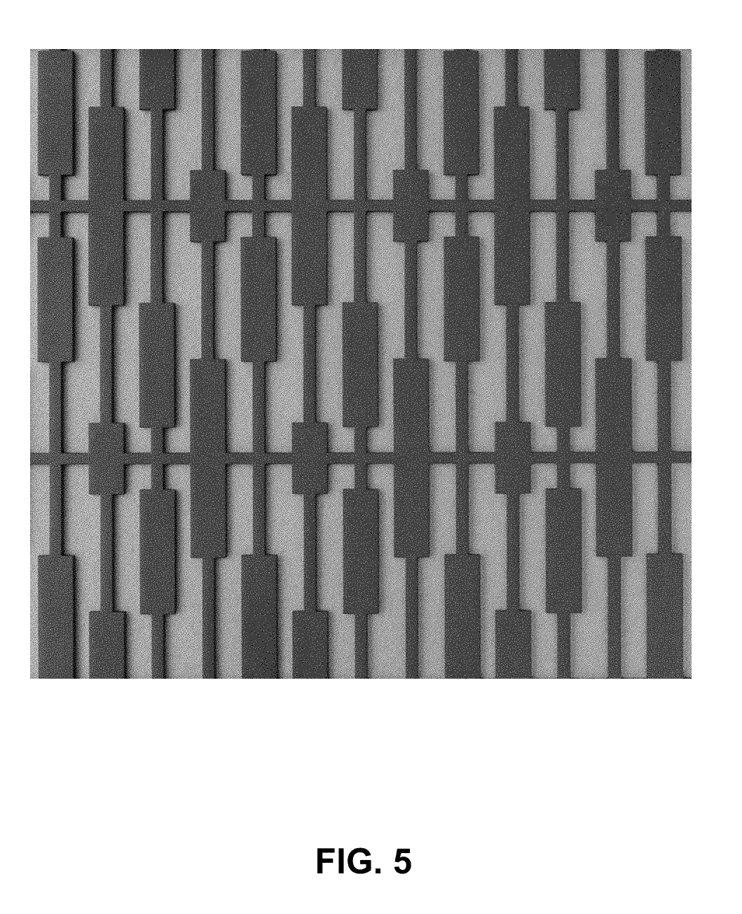

FIG. 5 shows a ceiling tile with a metal layer and a felt layer.

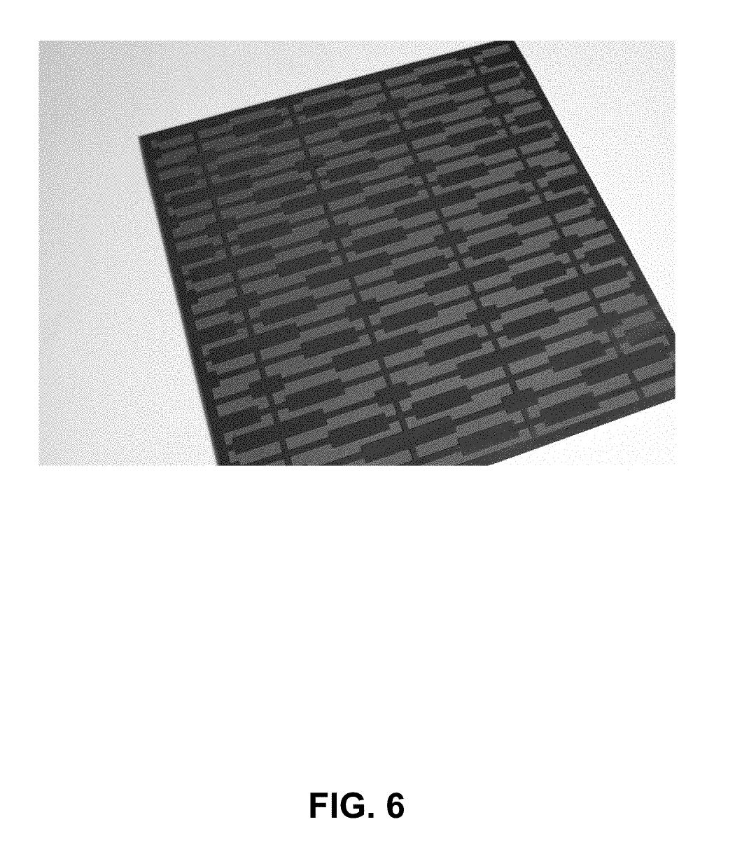

FIG. 6 shows another ceiling tile.

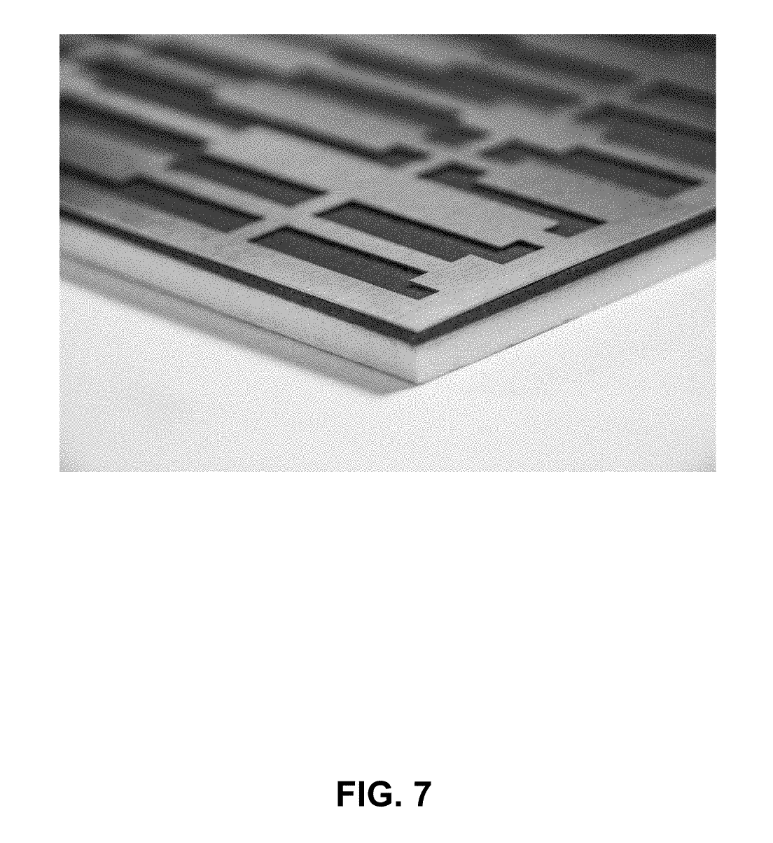

FIG. 7 shows a ceiling tile with layers of metal, felt, and acoustic board wherein, once installed, the felt layer would obscure the acoustic board but the felt layer would be visible through the metal layer. In some variations, the felt is a nonflammable material that provides color and may also absorb sound, as would the acoustic board.

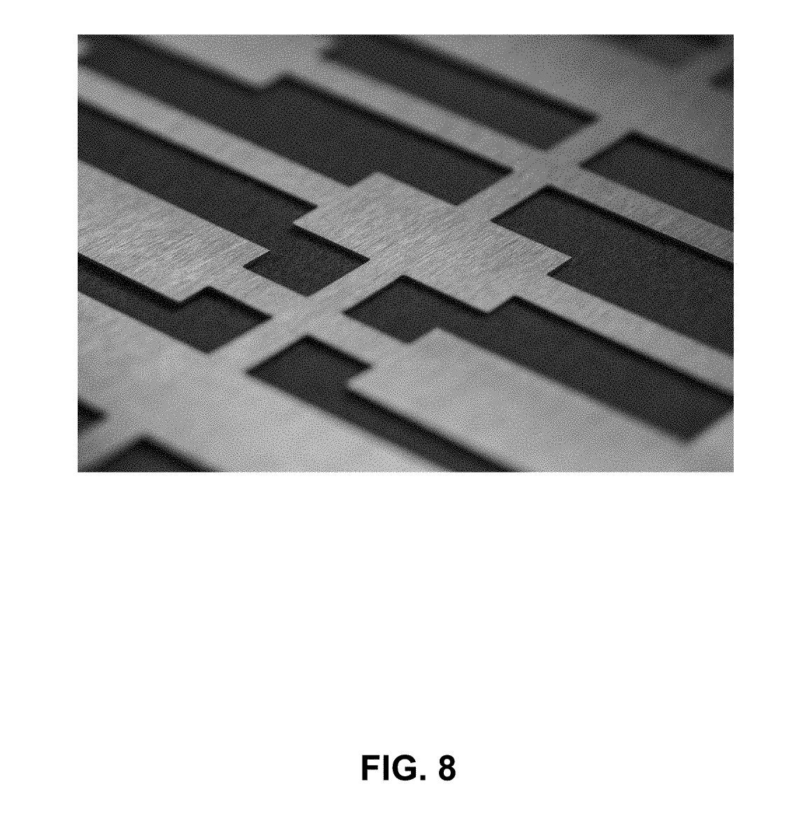

FIG. 8 shows a ceiling tile from an angled view, with the felt layer visible through the metal layer.

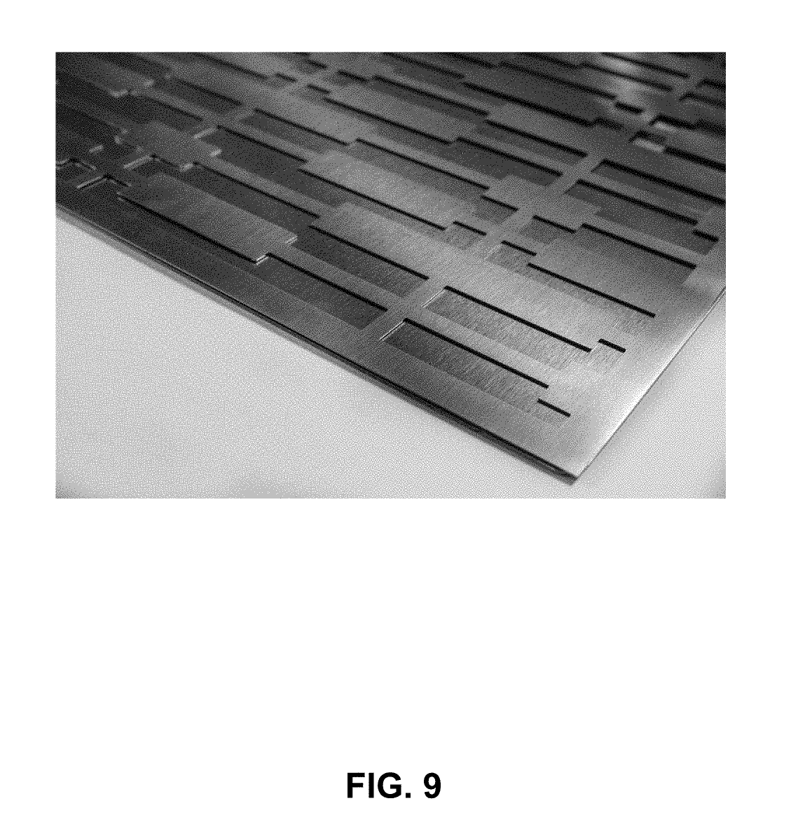

FIG. 9 shows a ceiling tile with a laser cut metal layer and a second metal layer above, and visible through, the laser cut metal layer; the laser cut metal layer and the second metal layer can be constructed of the same metal with the same surface texture and same color, or one or more of the metals used, surface texture, and color can be different between the laser cut metal layer and the second metal layer.

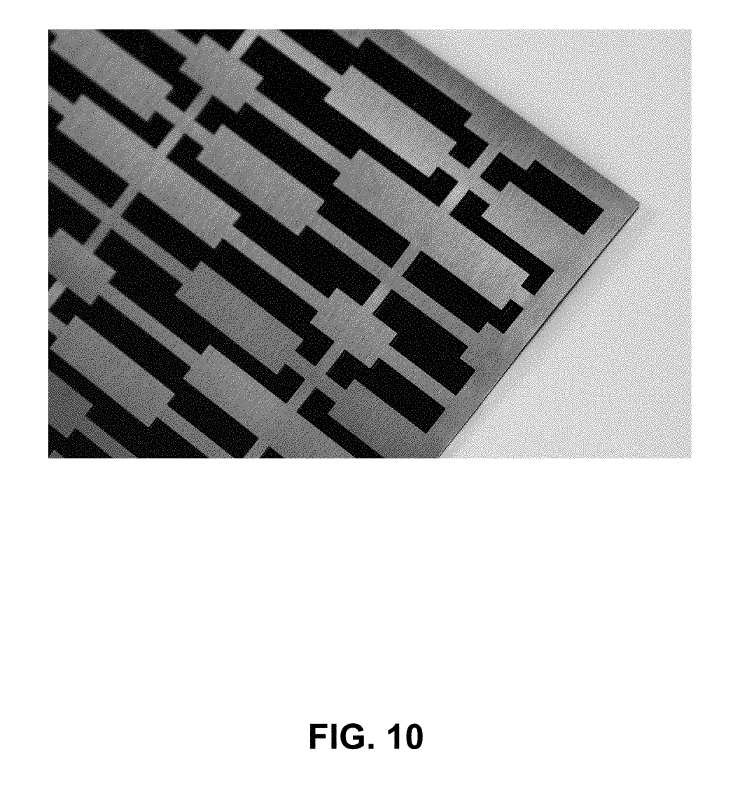

FIG. 10 is a view of a ceiling tile with metal under acoustic board and/or metal. The thickness of the metal might be a function of the size of the tiles. The tiles might be 12″×12″, 24″×12″, 24″×24″, or other sizes. The sizes might not be round numbers of inches, such as being 23.75″×23.75″ to accommodate a suspension system with mounting spans spaced 24″ apart. As an example of thickness, the metal might be aluminum of 22 gauge to 10 gauge, perhaps 0.090″ or 0.010″ thick, or more or less, as needed. If sagging over time is an issue, thicker aluminum can be used. It may be that sagging concerns are different for different patterns. Thus, for some patterns that are laser cut from aluminum, a first pattern provides less structural support relative to a second pattern, so the aluminum sheet used for the first pattern might be thicker than the aluminum sheet used for the second pattern.

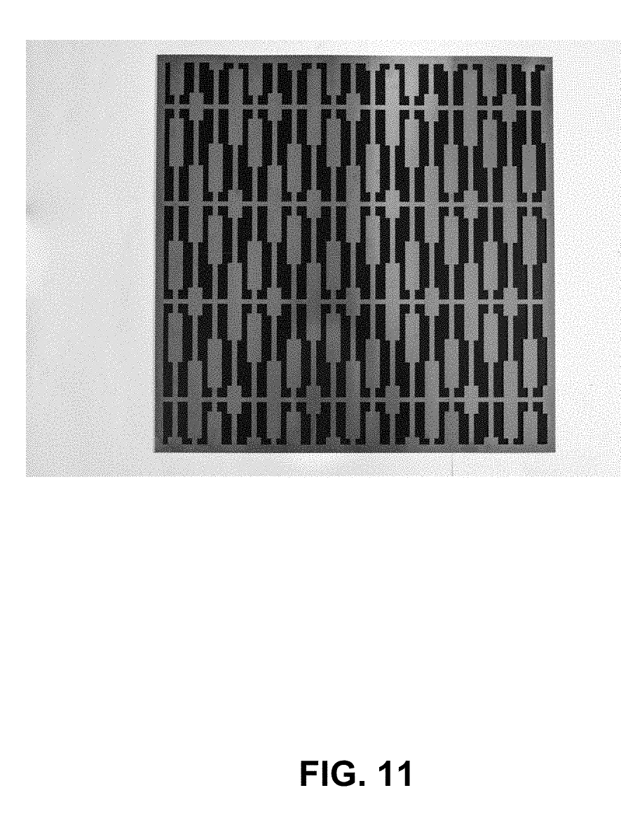

FIG. 11 shows another example of a ceiling tile.

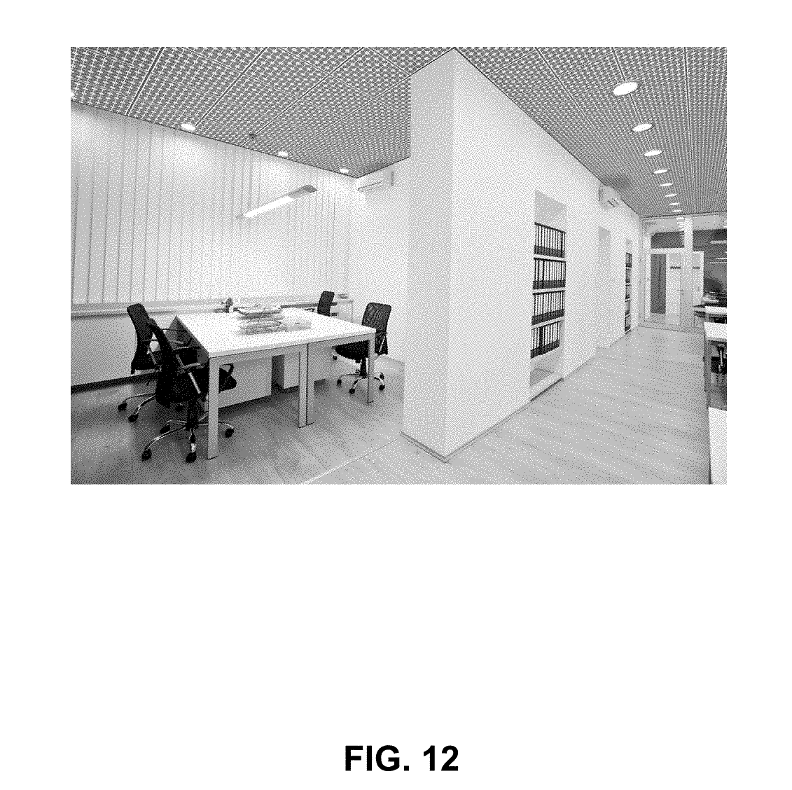

FIG. 12 shows an example of an installed ceiling comprising ceiling tiles with a metal layer under a felt layer where the felt layer is visible to occupants of an office environment.

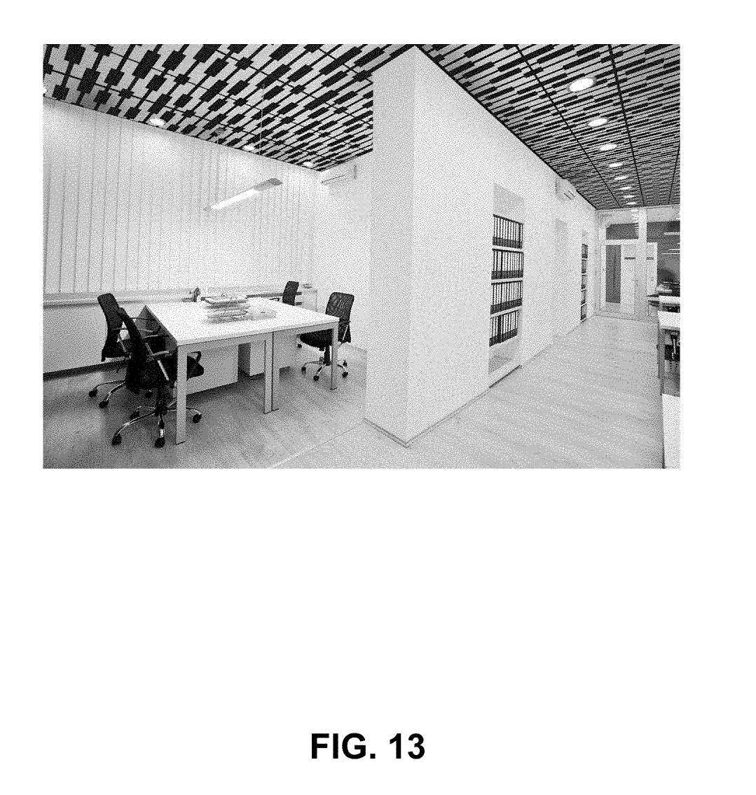

FIG. 13 shows an example of an installed ceiling comprising ceiling tiles with a metal layer under a felt layer where the felt layer is visible to occupants of an office environment and the metal layer is darker and/or less reflective than the felt layer. The second layer can be metal as shown, but in some instances, the second layer could also be acrylic or wood or other material that could be laser cut, punched or otherwise decoratively cut.

Operations of processes described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

All references, including publications, patent applications, and patents, cited herein are hereby incorporated by reference to the same extent as if each reference were individually and specifically indicated to be incorporated by reference and were set forth in its entirety herein.

What is claimed is:

1. A ceiling tile comprising:
a first layer comprising material suitable for use in ceiling tiles;
a second layer comprising a structurally stiff material, positioned to be vertically below the first layer when installed in a ceiling, wherein a material is structurally stiff when it can support its own weight and weights of other layers placed above the second layer, and wherein the second layer is of a material distinct from the material of the first layer; and
openings in the second layer such that, when installed in the ceiling, the first layer is visible through the openings in the second layer.

2. The ceiling tile of claim 1, wherein the second layer is metallic and the openings in the second layer are a cut metal design.

3. The ceiling tile of claim 1, wherein the first layer is felt and is supported the second layer, with the openings being sufficiently arranged so that the first layer is fully supported by portions of the second layer that are not the openings.

4. The ceiling tile of claim 1, wherein the second layer is of one or more materials selected from a group comprising steel, aluminum, copper, bronze, brass, and iron.

5. The ceiling tile of claim 1, wherein the first layer is of one or more materials selected from a group comprising acoustical fiber, wool, fabric, wood, leather, rubber, and acrylic.

6. The ceiling tile of claim 1, wherein the openings are formed by laser cutting a sheet of the material of the second layer.

7. The ceiling tile of claim 1, wherein the material of the first layer is readily permeable to air.

8. The ceiling tile of claim 1, wherein the material of the first layer is permeable to air, but blocks large particles.

9. The ceiling tile of claim 1, wherein the material of the first layer is a first nonflammable material and the structurally stiff material is a second nonflammable material.

10. The ceiling tile of claim 1, further comprising:
a third layer, positioned to be vertically below the first layer and above the second layer when installed in a ceiling, wherein the third layer is of a material distinct from the material of the first layer and the material of the second layer; and
third layer openings in the third layer such that, when installed in the ceiling, the first layer is visible through the openings in the second layer and the third layer openings.
